(19) United States
(12) Patent Application Publication
(10) Pub. No.: US 2021/0277782 A1
(43) Pub. Date: Sep. 9, 2021

(54) PRESSURE CAPTURE CANISTER

(71) Applicant: Solar Turbines Incorporated, San Diego, CA (US)

(72) Inventors: Yong Weon Kim, San Diego, CA (US); Jeffrey E. Tarczy, San Diego, CA (US)

(73) Assignee: Solar Turbines Incorporated, San Diego, CA (US)

(21) Appl. No.: 16/696,480

(22) Filed: Nov. 26, 2019

(51) Int. Cl. F01D 5/14

(52) U.S. Cl. CPC F01D 5/147; F05D 2240/55; F05D 2240/30; F05D 2220/32

(57) ABSTRACT

A pressure capture canister is disclosed. The pressure capture canister includes a body, a cap, and a seal. The cap and the seal are positioned within the body and are arranged to allow fluid communication from outside of the pressure capture canister to within the body. The seal can be selected to melt or soften at a temperature threshold.

### TECHNICAL FIELD

The present disclosure generally pertains to gas turbine engines. More particularly this application is directed toward a pressure capture canister.

### BACKGROUND

A gas turbine is a rotary power machine that uses air flowing continuously as a working medium and that converts thermal energy to mechanical work. The gas turbine generally includes three main components: a compressor, a combustor, and a turbine. At work, the compressor inhales air from an external atmosphere environment, and compresses the air by using an axial-flow compressor to increase pressure of the air, where at the same time, the temperature of the air also increases correspondingly. The compressed air is pressurized into the combustor and a mixture of the air and injected fuel burns to generate high temperature and high pressure gas. Then, the high temperature and high pressure gas enters the turbine and then does work by way of expansion, to push the turbine to drive the compressor and an externally loaded rotor to rotate together at a high speed, so that mechanical energy of gaseous or fluid fuel is partially converted to mechanical work, and electric work is output.

To improve reliability of the turbine, the operating environment within the turbine can be monitored to detect possible inefficiencies. Temperature sensors and pressure sensors can be installed on some important components (such as the turbine blades and stationary blades of the turbine). However to implementation of data transmission and power supply of the sensors may lead to increased costs and decreased structural integrity of turbine components.

U.S. Patent Publication No. 20190003332 to Chen et al., describes a sealing telemetry assembly used for a gas turbine. The gas turbine includes at least one turbine disk, and the sealing telemetry assembly includes a sealing cover and at least one power supply apparatus. The sealing cover is used to cover the turbine disk, and the sealing cover includes a cavity forming portion and a cover. At least one installation cavity is provided within the cavity forming portion, and the cover is fixed to the cavity forming portion. The power supply apparatus is configured in the installation cavity. A gas turbine, a sealing cover, and a manufacturing method of a sealing telemetry assembly are also provided. They can improve working performance of the gas turbine, reduce production costs, and monitor an internal working environment of the gas turbine.

The present disclosure is directed toward improvements in the art.

### SUMMARY

A pressure capture canister is disclosed herein. The pressure capture canister includes a sleeve, a cap, a body, and a seal. The sleeve having a bottom, and a tubular shell extending from the bottom. The tubular shell having an open top end opposite from the bottom and a top portion adjacent to the open top end. The cap is shaped to be received within the top portion of the tubular shell. The body is shaped to be received within the tubular shell. The body having a body bottom and a body tubular shell extending from the body bottom. The body tubular shell includes a body open top end opposite from the body bottom, and a body lip adjacent to the body open top end. The body lip is shaped to be aligned with the cap. The seal is shaped to be positioned between the body lip and the cap and extends along the body lip. The seal is selected to have a forging temperature that is lower than the forging temperature of the sleeve, the cap, and the body.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a schematic illustration of an exemplary gas turbine engine;

FIG. 2 is a cross-section view of a portion of the exemplary turbine rotor assembly from FIG. 1;

FIG. 3 is an enlarged cross-section view of a portion of the exemplary turbine rotor assembly along plane III-III from FIG. 2;

FIG. 4 is a side view of an exemplary pressure capture canister from FIG. 3;

FIG. 5 is a cross-section view of the exemplary pressure capture canister along line V-V FIG. 4, with an additional enlarged portion view;

FIG. 6 is a portion of a cross-section view focused on the seal from FIG. 5 along line VI-VI;

FIG. 7 is a cross-section view of another embodiment of a pressure capture canister;

FIG. 8 is a cross-section view of another embodiment of a pressure capture canister, with an additional enlarged portion view;

FIG. 9 is a side view of another embodiment of a pressure capture canister; and

FIG. 10 is a cross-section view of the pressure capture canister from FIG. 9.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

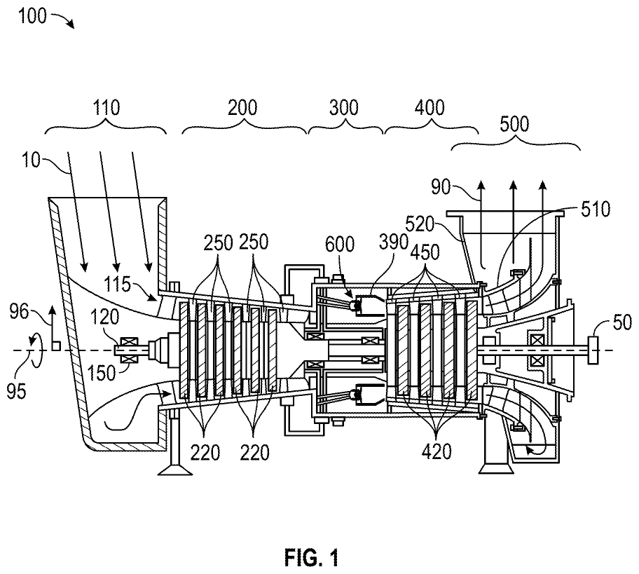

FIG. 1 is a schematic illustration of an exemplary gas turbine engine. Some of the surfaces have been left out or exaggerated for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a gas producer or compressor 200, a combustor 300, a turbine 400, an exhaust 500, and a power output coupling 50. The compressor 200 includes one or more compressor rotor assemblies 220. The combustor 300 includes one or more injectors 600 and includes one or more combustion chambers 390. The turbine 400 includes one or more turbine rotor assemblies 420. The exhaust 500 includes an exhaust diffuser 510 and an exhaust collector 520.

As illustrated, both compressor rotor assembly 220 and turbine rotor assembly 420 are axial flow rotor assemblies, where each rotor assembly includes a rotor disk that is circumferentially populated with a plurality of airfoils (“rotor blades”). When installed, the rotor blades associated with one rotor disk are axially separated from the rotor blades associated with an adjacent disk by stationary vanes 250 and 450 (“stator vanes” or “stators”) circumferentially distributed in an annular casing.

A gas (typically air 10) enters the inlet 110 as a “working fluid”, and is compressed by the compressor 200. In the compressor 200, the air 10 is compressed in an annular flow path 115 by the series of compressor rotor assemblies 220. In particular, the air 10 is compressed in numbered “stages”, the stages being associated with each compressor rotor assembly 220. For example, “4th stage air” may be associated with the 4th compressor rotor assembly 220 in the downstream or “aft” direction—going from the inlet 110 towards the exhaust 500). Likewise, each turbine rotor assembly 420 may be associated with a numbered stage. For example, first stage turbine rotor assembly 421 is the forward most of the turbine rotor assemblies 420. However, other numbering/naming conventions may also be used.

Once compressed air 10 leaves the compressor 200, it enters the combustor 300, where it is diffused and fuel is added. Air 10 and fuel are injected into the combustion chamber 390 via injector 600 and ignited. After the combustion reaction, energy is then extracted from the combusted fuel/air mixture via the turbine 400 by each stage of the series of turbine rotor assemblies 420. Exhaust gas 90 may then be diffused in exhaust diffuser 510 and collected, redirected, and exit the system via an exhaust collector 520. Exhaust gas 90 may also be further processed (e.g., to reduce harmful emissions, and/or to recover heat from the exhaust gas 90).

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

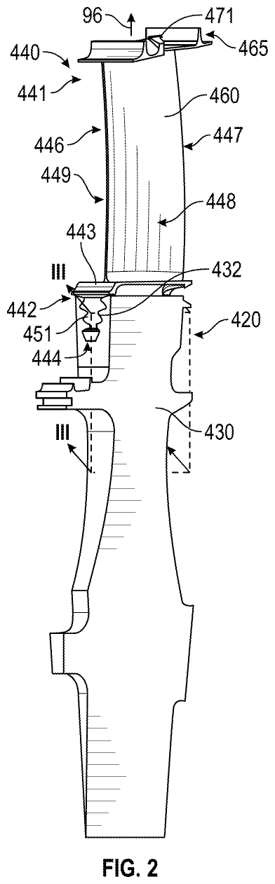

FIG. 2 is a cross-section view of a portion of the exemplary turbine rotor assembly from FIG. 1. In particular, a portion of the turbine rotor assembly 420 schematically illustrated in FIG. 1 is shown here in greater detail, but in isolation from the rest of gas turbine engine 100. The portion of the turbine rotor assembly 420 shown in FIG. 2 includes a portion or slice of a turbine rotor disk 430 cross sectioned on both sides corresponding approximately to the area under a turbine blade 440. The turbine blade 440 may include a base 442 including a platform 443 and a blade root 451. For example, the blade root 451 may incorporate “fir tree”, “bulb”, or “dove tail” roots, to list a few. Correspondingly, the turbine rotor disk 430 may include a circumferentially distributed slot or blade attachment groove 432 configured to receive and retain the turbine blade 440. In particular, the blade attachment groove 432 may be configured to mate with the blade root 451, both having a reciprocal shape with each other. In addition the blade root 451 may be slidably engaged with the blade attachment groove 432, for example, in a forward-to-aft direction.

The turbine blade 440 may further include an airfoil 441 extending radially outward from the platform 443 and away from the turbine rotor disk 430. The airfoil 441 may have a complex, geometry that varies radially. For example the cross section of the airfoil 441 may lengthen, thicken, twist, and/or change shape as it radially approaches the platform 443 inward from an upper shroud 465. The overall shape of airfoil 441 may also vary from application to application.

The turbine blade 440 is generally described herein with reference to its installation and operation. In particular, the turbine blade 440 is described with reference to both a radial 96 of center axis 95 (FIG. 1) and the aerodynamic features of the airfoil 441. The aerodynamic features of the airfoil 441 include a leading edge 446, a trailing edge 447, a pressure side 448, and a lift side 449 (also referred to as suction side). As discussed above, airfoil 441 also extends radially between the platform 443 and the upper shroud 465. The upper shroud 465 may be located outward from the airfoil 441 and is disposed opposite from the root end 444. The upper shroud 465 can include an abutment 471 located on the side of the upper shroud 465. Thus, when describing the turbine blade 440 as a unit, the inward direction is generally radially inward toward the center axis 95 (FIG. 1), with its associated end called a “root end” 444. Likewise the outward direction is generally radially outward from the center axis 95 (FIG. 1), with its associated end being defined by the shroud 465.

In addition, when describing the airfoil 441, the forward and aft directions are generally measured between its leading edge 446 (forward) and its trailing edge 447 (aft) When describing the flow features of the airfoil 441, the inward and outward directions are generally measured in the radial direction relative to the center axis 95 (FIG. 1).

Finally, certain traditional aerodynamics terms may be used herein for clarity, but without being limiting. For example, while it will be discussed that the airfoil 441 (along with the entire turbine blade 440) may be made as a single metal casting, the outer surface of the airfoil 441 (along with its thickness) is descriptively called herein the “skin” 460 of the airfoil 441.

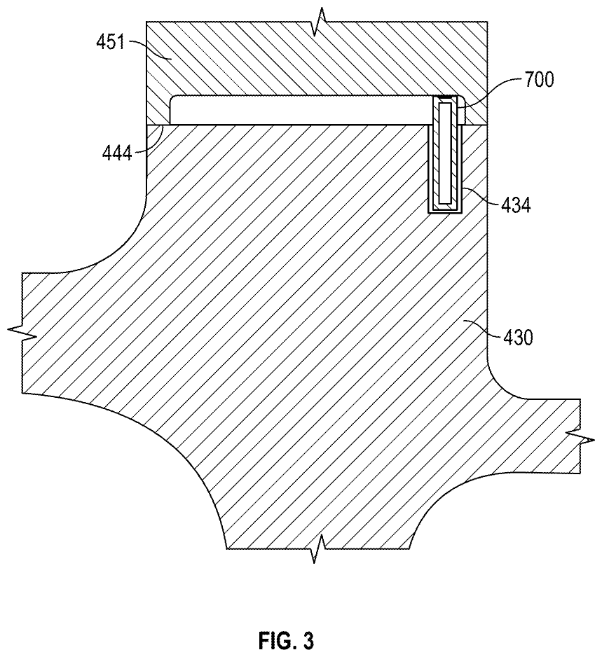

FIG. 3 is an enlarged cross-section view of a portion of the exemplary turbine rotor assembly along plane from FIG. 2. The rotor disk 430 may include a slot 434 proximate to the interface between the blade root 451 and root end 444 of the turbine blade 440 and the rotor disk 430. The slot 434 can be shaped to receive a pressure capture canister 700. In FIG. 3 the pressure capture canister 700 is shown simplistically for clarity of the drawing. The pressure capture canister 700 is shown and described in greater detail in later figures and accompanying description. In an embodiment the pressure capture canister 700 is placed into the slot 434 prior to the turbine blade 440 engaging with the rotor disk 430. The pressure capture canister 700 can be placed between the blade root 451 and the rotor disk 430. In an embodiment the blade root 451 prevents the pressure capture canister 700 from moving out of the slot 434.

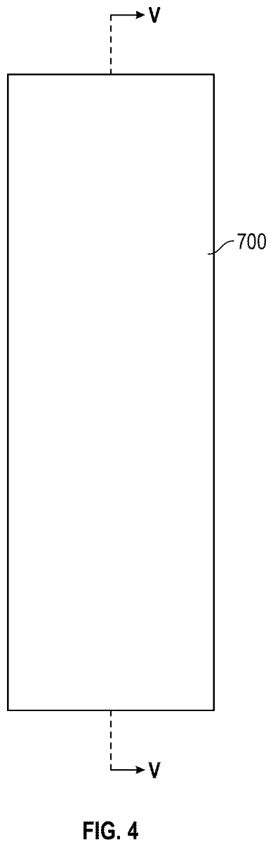

FIG. 4 is a side view of an exemplary pressure capture canister from FIG. 3. The pressure capture canister 700 can be shaped as hollow cylinder.

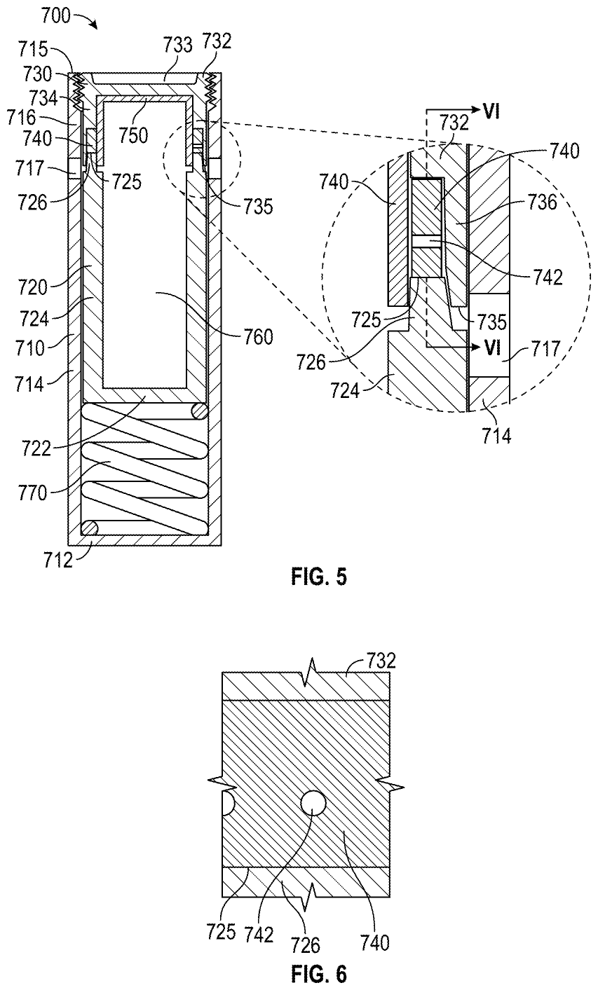

FIG. 5 is a cross-section view of the exemplary pressure capture canister along line V-V FIG. 4, with an additional enlarged portion view. The pressure capture canister 700 can comprise a sleeve 710, a body 720, a cap 730, and a seal 740.

The sleeve 710 can have a hollow cylinder shape. The sleeve 710 can include a bottom 712 and a tubular shell 714 (sometimes referred to as the shell). Where the drawing includes multiple instances of the same feature, for example air passage 717, the reference number is only shown in connection with one instance of the feature to improve the clarity and readability of the drawing. This is also true in other drawings which include multiple instances of the same feature.

The bottom 712 can have a disk shape. The tubular shell 714 can extend from the bottom 712. In an embodiment the tubular shell 714 can extend from proximate the perimeter of the bottom 712. The tubular shell 714 can include an open top end 715 located opposite from the bottom 712. The tubular shell 714 can include a top portion 716 located adjacent to the open top end 715. The tubular shell 714 can include one or more air passages 717 (sometimes referred to as an aperture) located proximate to the top portion 716 and extending through the tubular shell 714.

In an embodiment an inner wall of the top portion 716 and an outside of the cap 730 are reciprocally threaded so that cap 730 can be screwed into the tubular shell 714.

The body 720 can be shaped to be received by the tubular shell 714. In an embodiment the body 720 is positioned within the tubular shell 714. The body 720 can have a hollow cylinder shape. The body 720 can include a body bottom 722 and a body tubular shell 724 (sometimes referred to as a body shell).

The body bottom 722 can have a disk shape. The body tubular shell 724 can extend from the body bottom 722. In an embodiment the body tubular shell 724 can extend from proximate the perimeter of the body bottom 722. The body tubular shell 724 can include a body open top end 725 located opposite from the body bottom 722 and a body lip 726 located adjacent the body open top end 725. The body lip 726 can be located proximate to the air passage 717. The body lip 726 can taper narrower the further it extends away from the body bottom 722.

The cap 730 can be shaped to be received by the tubular shell 714 proximate the open top end 715. In an embodiment the cap 730 is positioned within the tubular shell 714. The cap 730 can have a hollow cylinder shape. The cap 730 can include a cap top 732 and a cap tubular shell 734 (sometimes referred to as a cap shell).

The cap top 732 can have a disk shape. The cap top 732 can have a depression 733. The cap tubular shell 734 can extend from the cap top 732. In an embodiment the cap tubular shell 734 can extend from proximate the perimeter of the cap top 732. The cap tubular shell 734 can include a cap open bottom end 735 located opposite from the cap top 732 and a cap lip 736 located adjacent the cap open bottom end 735. The cap lip 736 can be located proximate to the air passage 717. The cap lip 736 can taper narrower the further it extends away from the cap top 732. In embodiment the cap lip 736 is positioned between the body lip 726 and the tubular shell 714. The cap lip 736 can be shaped to align with the shape of the body lip 726, such as being positioned adjacent to the body lip 726, contouring the body lip 726, surrounding the body lip 726, or concentric with the body lip 726. In an embodiment the body lip 726 can be received by the cap lip 736.

The seal 740 can be shaped to be positioned between the body open top end 725 and the cap tubular shell 734. The seal 740 can extend along the body lip 726 and have a ring shape. The seal 740 can be selected to have a melting temperature that is lower than the melting temperature of the sleeve 710, the body 720, and the cap 730. In certain embodiments the seal 740 can have a melting temperature between 600 and 1600 degrees Fahrenheit. In an embodiment the seal can be made from a brazing material such as lead, aluminum alloys, and other metals. In embodiments the seal 740 can be selected to have a forging temperature that is lower than the forging temperature of the sleeve 710, the body 720, and the cap 730.

The seal 740 can include one of more air holes 742 extending through the seal 740. In an embodiment the air hole 742 is located closer to the body lip 726.

The pressure capture canister 700 can further include a sleeve insert 750. The sleeve insert 750 can be shaped to be received by the cap 730 and the body lip 726. In an embodiment the sleeve insert 750 is positioned within the cap 730, the body lip 726, and the seal 740. The sleeve insert 750 can have a hollow cylinder shape with an open bottom and a closed top. The sleeve insert 750 can be positioned to abut the cap top 732.

The pressure capture canister 700 can include a cavity 760. In an embodiment the cavity 760 is by the body 720 and the sleeve insert 750.

The pressure capture canister 700 can further include a spring element 770 (sometimes referred to as a spring). The spring element 770 can be positioned within the sleeve 710. The spring element 770 can be positioned between the bottom 712 of the sleeve 710 and the body bottom 722. In an embodiment the spring element 770 abuts the bottom 712 and the body bottom 722.

FIG. 6 is a portion of a cross-section view focused on the seal from FIG. 5 along line VI-VI. In FIG. 6 the air holes 742 have been positioned for clarity and ease of explanation. The air holes 742 can have a circular cross section and can be spaced apart from one another. In other examples the air holes 742 have a rectangular, triangular, oval, or other cross sections defined by curved and/or straight lines.

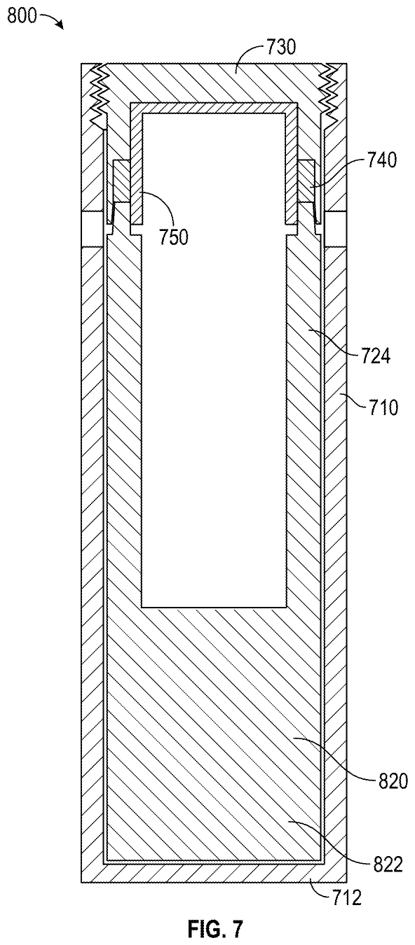

FIG. 7 is a cross-section view of another embodiment of a pressure capture canister. Structures and features previously described in connection with earlier described embodiments may not be repeated here with the understanding that, when appropriate, that previous description applies to the embodiment depicted in FIG. 7. Additionally, the emphasis in the following description is on variations of previously introduced features or elements. Also, some reference numbers for previously descripted features are omitted.

A pressure capture canister 800 can include a sleeve 710, a body 820, a cap 730, a seal 740, and a sleeve insert 750. The body 820 can include a body bottom 822 and a body tubular shell 724. In an embodiment the body bottom 822 can extend from the body tubular shell 724 to adjacent the bottom 712.

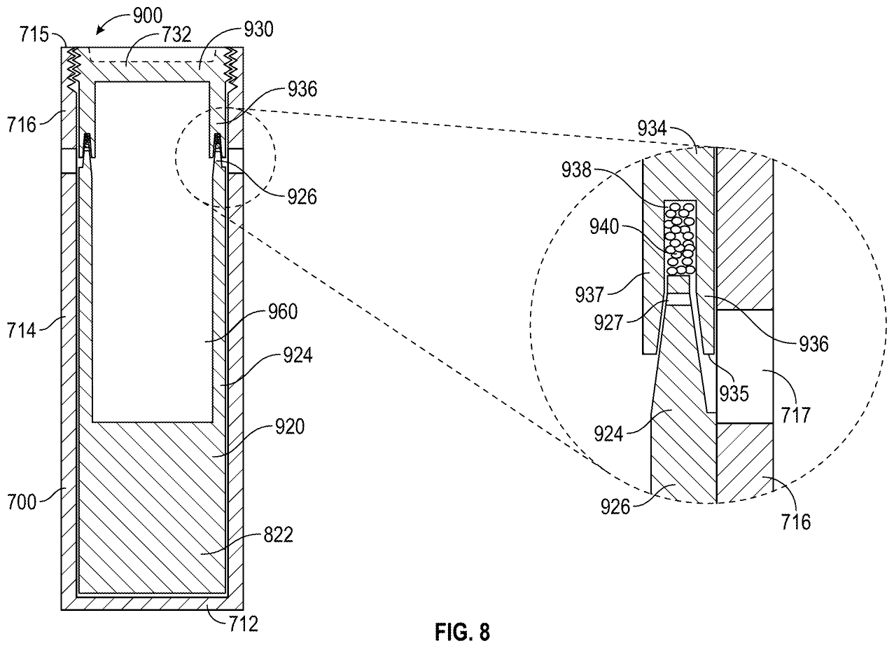

FIG. 8 is a cross-section view of another embodiment of a pressure capture canister, with an additional enlarged portion view. A pressure capture canister 900 can include a sleeve 710, a body 920, a cap 930, and a seal 940. The body 920 can include a body bottom 822 and a body tubular shell 924. In an embodiment the body bottom 922 can extend from the body tubular shell 924 to adjacent the bottom 712.

The body tubular shell 924 can extend from the body bottom 722. In an embodiment the body tubular shell 924 can extend from proximate the perimeter of the body bottom 722. The body tubular shell 924 can include a body open top end 925 located opposite from the body bottom 722 and a body lip 926 located adjacent the body open top end 925. The body lip 926 can be located proximate to the air passage 717. The body lip 926 can taper narrower as it extends away from the body bottom 722. The body lip 926 can include a body air passage 927 that extends through the body lip 926 and can be in fluid communication with the air passage 717 of the tubular shell 714.

The cap 930 can be shaped to be received by the tubular shell 714 proximate the open top end 715. In an embodiment the cap 930 is positioned within the tubular shell 714. The cap 930 can have a hollow cylinder shape. The cap 930 can include a cap top 732 and a cap tubular shell 934 (sometimes referred to as a cap shell).

In an embodiment the cap tubular shell 934 can extend from proximate the perimeter of the cap top 732. The cap tubular shell 934 can include a cap open bottom end 935 located opposite from the cap top 732, a first cap lip 936 (sometimes referred to as cap lip) and a second cap lip 937. The first cap lip 936 and the second cap lip 937 can be located adjacent the cap open bottom end 935. The first cap lip 936 and the second cap lip 937 can be located proximate to the air passage 717. The first cap lip 936 and/or the second cap lip 937 can taper narrower the further they extend away from the cap top 732. The second cap lip 937 can be space from and located inward of the first cap lip 936. A cap lip gap 938 can be defined by the first cap lip 936 and the second cap lip 937.

In embodiment the first cap lip 936 is positioned between the body lip 926 and the tubular shell 714. The second cap lip 937 can be positioned inward of the body lip 926. The first cap lip 936 and the second cap lip 937 can be shaped to align with the shape of the body lip 926, such as being positioned adjacent to the body lip 926, contouring the body lip 926, surrounding the body lip 926, or concentric with the body lip 926. In an embodiment the body lip 926 can be received by the first cap lip 936 and the second cap lip 937

The seal 940 can be shaped to be positioned between the body open top end 725 and the cap tubular shell 934. In an embodiment the seal 940 is positioned within the cap lip gap 938, between the first cap lip 936 and the second cap lip 937. The seal 940 can be shaped as wire wrapped within the cap lip gap 938. In an example the seal 940 can be a powder of material. In certain embodiments the seal 940 can be selected to have a melting temperature that is lower than the melting temperature of the sleeve 710, the body 920, and the cap 930. In embodiments the seal 940 can be selected to have a forging temperature that is lower than the forging temperature of the sleeve 710, the body 920, and the cap 930.

The pressure capture canister 900 can include a cavity 960. In an embodiment the cavity 960 is by the body 920 and the cap 930.

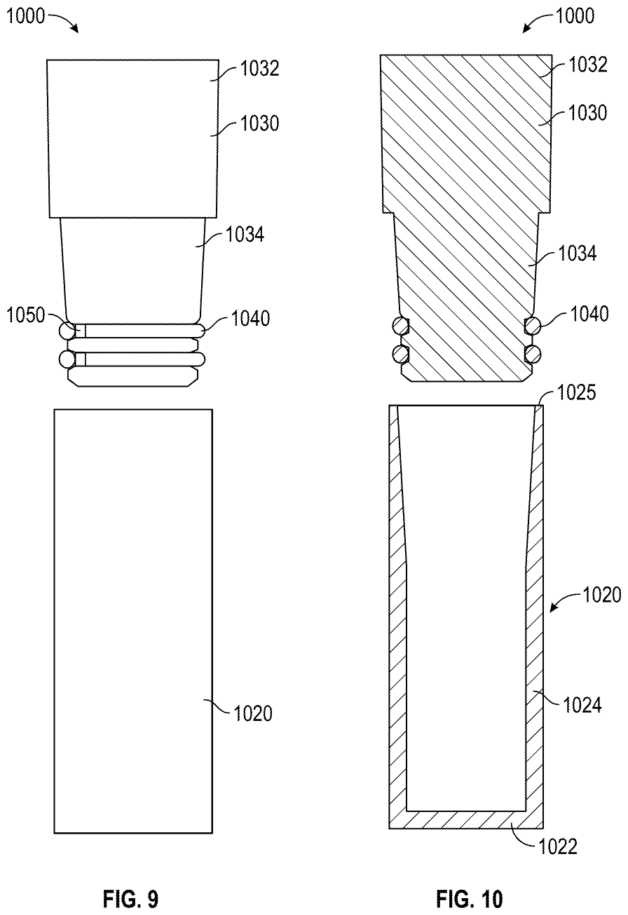

FIG. 9 is a side view of another embodiment of a pressure capture canister. A pressure capture canister 1000 can include a sleeve a body 1020, a cap 1030, and a seal 1040. The body 1020 can include a body bottom 1022 and a body tubular shell 924. In an embodiment the body bottom 922 can extend from the body tubular shell 924 to adjacent the bottom 712.

The cap 1030 can have a cap top portion 1032 and a cap bottom portion 1034. The cap top portion 1032 can have a cylindrical shape. The cap bottom portion 1034 can extend from the cap top portion 1032. In an embodiment the cap top portion 1032 extends outwards of the cap bottom portion 1034. The cap bottom portion 1034 can taper narrower the further it extends from the cap top portion 1032. In an embodiment the cap bottom portion has a frusto conical shape.

A seal 1040 can extend along the outer surface of the cap bottom portion 1034. In an embodiment the seal extends partially around the cap bottom portion 1034 and has a seal gap 1050. In an example the cap bottom portion 1034 has grooves that are shaped to receive the seal 1040.

FIG. 10 is a cross-section view of the pressure capture canister from FIG. 9. The body 1020 can include a body bottom 1022 and a body shell 1024 (sometimes referred to as body tubular shell). The body shell 1024 can extend from the body bottom 1022. In an embodiment the body shell 1024 can extend from proximate the perimeter of the body bottom 1022. The body shell 1024 can include a body open top end 1025 located opposite from the body bottom 1022.

The cap bottom portion 1034 with the seal 1040 can be shaped to be received by the body shell 1024 proximate the body open top end 1025.

### INDUSTRIAL APPLICABILITY

The present disclosure generally applies to a pressure capture canister 700, 800, 900, 1000 for gas turbine engines 100. The described embodiments are not limited to use in conjunction with a particular type of gas turbine engine 100, but rather may be applied to stationary or motive gas turbine engines, or any variant thereof. Gas turbine engines, and thus their components, may be suited for any number of industrial applications, such as, but not limited to, various aspects of the oil and natural gas industry (including include transmission, gathering, storage, withdrawal, and lifting of oil and natural gas), power generation industry, cogeneration, aerospace and transportation industry, to name a few examples.

Generally, embodiments of the presently disclosed pressure capture canister 700, 800, 900, 1000 are applicable to the use, assembly, manufacture, operation, maintenance, repair, and improvement of gas turbine engines 100, and may be used in order to improve performance and efficiency, decrease maintenance and repair, and/or lower costs. In addition, embodiments of the presently disclosed pressure capture canister 700, 800, 900, 1000 may be applicable at any stage of the gas turbine engine's 100 life, from design to prototyping and first manufacture, and onward to end of life. Accordingly, the pressure capture canister 700, 800, 900, 1000 may be used in a first product, as a retrofit or enhancement to an existing gas turbine engine, as a preventative measure, or even in response to an event.

Measuring pressure from a rotating body in a high temperature environment can be difficult and costly. For example measuring the pressure within the turbine 400, between a turbine blade 440 and a rotor disk 430 of an operating gas turbine engine 100. In an example, by acquiring measurement of pressure within the gas turbine engine 100, can lead to more accurate control of secondary cooling air to prevent excessive secondary cooling air consumption and thus have a first order improvement on engine cycle efficiency.

In the disclosed embodiment, the pressure capture canister 700, 800, 900, 1000 can be configured to capture operating pressure within the turbine 400 around a predetermined temperature threshold.

Referring to FIGS. 5, 7, and 8 a body 720, 820, 920, a cap 730, 930, a seal 740, 940, a sleeve insert 750 (FIGS. 5 and 7 only), and a spring element 770 (FIG. 5 only) are placed within a sleeve 710 and make up the pressure capture canister 700, 800, 900. The depression 733 in the cap 730, 930 can be shaped to receive a torqueing device, such as an allen wrench or screw driver, and be rotated such that the threaded outside of the cap 730, 930 can reciprocally thread with the inner wall of the top portion 716 of the tubular shell 714. As the cap 730, 930 is further inserted into the tubular shell 714, the cap 730, 930 can contact the seal 740, 940, and the seal 740, 940 can continue to contact the body lip 726, 926. As the cap 730, 930 is inserted further, the spring element 770 begins to compress relative to the cap 730 position. The spring element 770 provides reaction forces against the bottom 712 and the body 720 in relation to the compressed amount. In FIGS. 7 and 8 the spring element 770 is replaced with the body bottom 822 positioned to contact the bottom 712 and provide reaction forces against the bottom 712.

The tubular shell 714, the air passage 717, the body lip 726, 926, the cap lip 736, 936, the seal 740, 940, and the sleeve insert 750 are shaped and positioned to provide fluid communication between the cavity 760, 960 and the air outside of the pressure capture canister 700, 800, 900.

Referring to FIGS. 9 and 10, a body 1020, a cap 1030, and a seal 1040 make up the pressure capture canister 1000. The cap bottom portion 1036 with the seal 1040 can be placed within the body shell 1026 such that the seal 1040 contacts the inner wall of the body shell 1026. The seal gap 1050 can be positioned adjacent to the inner wall of the body shell 1026 and define a passage with the body shell 1026 that provides fluid communication from within the body 1020 to outside of the body 1020.

The pressure capture canister 700, 800, 900, 1000 can be placed within a slot 434 (FIG. 3) of a rotor disk 430 of a gas turbine engine 100. A turbine blade 440 can then be installed and connected to the rotor disk 430, thereby covering the pressure capture canister 700, 800, 900, 1000 and preventing the pressure capture canister 700, 800, 900, 1000 from being removed from the slot 434. During operation of the gas turbine engine temperature increases. The seal 740, 940, 1040 can be selected to melt or soften at a desired temperature threshold.

Referring to FIG. 5 once the temperature threshold is met, the seal 740 melts or softens and the spring pushes the body 720 up towards the cap 730, blocking off fluid communication between the cavity 760 and the outside of the pressure capture canister 700, thereby capturing the ambient pressure the moment the temperature threshold is met.

Referring to FIGS. 7 and 8, once the temperature threshold is met, the seal 740, 940 softens and the weight of the body 820, 920 pushes towards the cap 730, 930 due to the centrifugal force generated by the rotating rotor disk 430 during operation of the gas turbine engine 100. As the body 820, 920 pushes against the cap 730, 930, the fluid communication between the cavity 760 and the outside of the pressure capture canister 800, 900 is blocked off, thereby capturing the ambient pressure the moment the temperature threshold is met. Once the seal 740, 940 softens and the centrifugal force pushes the body 820,920 towards the cap 730, 930, friction forces generated by the movement of the body 820, 920 maintain the seal between the cavity 760 and outside of the pressure capture canister 800, 900. Referring to FIG. 7, the frictional force can be between the body lip 726, the cap lip 736, and the sleeve insert 750. Referring to FIG. 8, the frictional force can be between the body lip 926, the first cap lip 936, and the second cap lip 937.

Referring to FIGS. 9 and 10, once the temperature threshold is met, the seal 1040 melts or softens and the weight of the cap 1030 pushes towards the body 1020 due to the centrifugal acceleration generated by the rotating rotor disk 430 during operation of the gas turbine engine 100 and the reaction force between the cap 1030 and the turbine blade 440. As the cap 1030 pushes against the body 1020 the fluid communication between the cavity within body 1020 and the outside of the pressure capture canister 1000 is blocked off, thereby capturing the ambient pressure the moment the temperature threshold is met. Once the seal 1040 softens and the centrifugal force pushes the cap 1030 towards the body 1020, friction forces generated by the movement of the cap 1030 maintain the seal between the space within the body 1020 and outside of the pressure capture canister 1000. The frictional force can be between the body shell 1024 and the cap bottom portion.

The pressure capture canister 700, 800, 900, 1000 can be later removed from the slot 434 after operation of the gas turbine engine 100 has ceased. The pressure within the pressure capture canister 700, 800, 900, 1000 can be measured, for example, by piercing the pressure capture canister 700, 800, 900, 1000. The ambient temperature can be measured at the moment the pressure is measured and used to determine the pressure and temperature ratio constant. The determined pressure and temperature ratio constant can be used with the temperature threshold value to determine the pressure at the moment the temperature threshold was met.

Although this invention has been shown and described with respect to detailed embodiments thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention.

In particular, the described embodiments are not limited to use in conjunction with a particular type of gas turbine engine. For example, the described embodiments may be applied to stationary or motive gas turbine engines, or any variant thereof. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

What is claimed is:

1. A pressure capture canister, the pressure capture canister comprising:
a sleeve having
a bottom, and
a tubular shell extending from the bottom, the tubular shell having
an open top end opposite from the bottom, and
a top portion adjacent to the open top end;
a cap shaped to be received within the top portion of the tubular shell;
a body shaped to be received within the tubular shell, the body having
a body bottom, and
a body tubular shell extending from the body bottom, the body tubular shell having
a body open top end opposite from the body bottom, and
a body lip adjacent to the body open top end, the body lip shaped to be aligned with the cap; and
a seal shaped to be positioned between the body lip and the cap and extend along the body lip, the seal selected to have a forging temperature that is lower than the forging temperature of the sleeve, the cap, and the body.

2. The pressure capture canister of claim 1, wherein the tubular shell of the sleeve further includes an air passage extending through the top portion.

3. The pressure capture canister of claim 1, wherein an inner wall of the top portion of the tubular shell and the outside of the cap are reciprocally threaded.

4. The pressure capture canister of claim 1, wherein the cap further includes
a cap top; and
a cap tubular shell extending away from the cap top, the cap tubular shell tapering narrower opposite from the cap top.

5. The pressure capture canister of claim 1, wherein the body lip tapers narrower opposite from the body bottom.

6. The pressure capture canister of claim 2, wherein the seal further includes an air hole extending through the seal.

7. The pressure capture canister of claim 6, wherein the seal is shaped as a ring.

8. The pressure capture canister of claim 1, wherein the pressure capture canister further comprises a spring shaped to fit within the tubular shell of the sleeve between the bottom and the body bottom.

9. The pressure capture canister of claim 1, wherein the pressure capture canister further comprises a sleeve insert shaped to be positioned within the cap tubular shell and to be aligned with the body lip and the seal.

10. A pressure capture canister comprising:
a sleeve having
a bottom, and
a tubular shell extending from the bottom, the tubular shell having
an open top end opposite from the bottom,
a top portion adjacent to the open top end, and
an air passage extending through the tubular shell;
a body positioned within the shell of the sleeve, the body having
a body bottom, and
a body shell extending from the body bottom, the body shell having
a body open top end opposite from the body bottom, and
a body lip adjacent to the body open top end;
a cap at least partially positioned within the tubular shell of the sleeve, the cap having
a cap top located proximate the top portion of the tubular sleeve, and
a cap shell extending from the cap top to adjacent the body lip; and
a seal positioned between the body lip and the cap.

11. The pressure capture canister of claim 10, wherein the seal is selected to have a melting temperature that is lower than the melting temperature of the sleeve, the cap, and the body.

12. The pressure capture canister of claim 10, wherein the seal has a melting temperature between 600 degrees Fahrenheit to 1600 degrees Fahrenheit.

13. The pressure capture canister of claim 10, wherein the pressure capture canister further comprises a sleeve insert positioned within the cap shell and aligned with the body lip and the seal.

14. The pressure capture canister of claim 10, wherein the pressure capture canister further comprises a spring positioned within the tubular shell of the sleeve and positioned between the body bottom and the bottom of the sleeve.

15. The pressure capture canister of claim 10, wherein the seal further includes an air hole extending through the seal and in fluid communication with the air passage.

16. The pressure capture canister of claim 10, wherein the body lip tapers narrower the further it is positioned from the body bottom.

17. A pressure capture canister comprising:
a sleeve having
a bottom, and
a shell extending from proximate a perimeter of the bottom, the shell having
an open top end opposite from the bottom,
a top portion adjacent to the open top end, and
an aperture in the top portion;
a cap positioned within the top portion of the shell; the cap having
a cap top located proximate the top portion of the tubular sleeve, and
a cap shell extending from the cap top and along the shell, the cap shell having a cap lip opposite from the cap top,
a body positioned within the shell, the body having
a body bottom, and
a body shell extending from the body bottom, the body shell having
a body open top end opposite from the body, and
a body lip adjacent to the body open top end, the body lip aligned with the cap lip; and
a seal between the body lip and cap, the seal extends along the body lip and the cap lip, the seal selected to have a melting temperature that is lower than the melting temperature of the sleeve, the cap, and the body.

18. The pressure capture canister of claim 17, wherein an inner wall of the top portion of the shell and the outside of the cap are reciprocally threaded so that the cap can be screwed in to the shell.

19. The pressure capture canister of claim 17, wherein the cap lip tapers narrower opposite from the cap top.

20. The pressure capture canister of claim 17, wherein the seal further includes an air hole extending through the seal.
